(19) United States
(12) Patent Application Publication
(10) Pub. No.: US 2009/0202326 A1
(43) Pub. Date: Aug. 13, 2009

(54) Cement truck elevator for additives

(76) Inventor: Dustin Cheyenne Strahler, Marietta, OH (US)

Correspondence Address: Jason H. Foster, 7632 Slate Ridge Blvd., Reynoldsburg, OH, 43068, US

(21) Appl. No.: 11/895,916

(22) Filed: Aug. 28, 2007

(51) Int. Cl. B65G 65/00

(52) U.S. Cl. 414/406; 414/410

(57) ABSTRACT

Disclosed is a lift elevator that utilizes a winch motor and a moveable platform. The lift Elevator includes cables, tubular frame and guides. These provide controls to a platform upon which a bucket of additives can be loaded into a cement truck mixer. To maintain ease of operation, control switches are placed at both top and bottom of the device. These controls allow upward and downward motion. They are also automatically stopped at both top and bottom of the motion by limit switches. Also provided are E-stop switches in case an emergency stop is required. By placing additional operator safety belts, connected to a “Dead Man” Switch, greater operation safety is provided. All switches have “wash down” capability for additional protection, increased durability and life cycle. There would also be a light in the cab of said vehicle showings its operator that everything was locked in the proper position and its truck could now be moved.

### FIELD OF THE INVENTION

The present invention is directed towards an elevator to be added to a cement mixing truck. More specifically, the present invention is directed towards allowing the driver to lift products in buckets automatically so colors or other additives may be added to each batch of concrete to meet customer requirements.

### BACKGROUND

The use of an elevator to lift buckets of additives in greater safety and ease then the present use of a ladder with no safety devices. Generally, buckets of concrete additives are carried up a ladder by the truck driver and then dumped into the mixer. Accordingly, the weight of the bucket, up to over 50 pounds, is awkward and causes the driver to put himself in a position that could cause back or upper body trauma. The elevator allows the weight to be handled easily and the driver only has to remove the bucket from the elevator's lift platform and dump the contents into the mixer opening. Electrical switches are utilized for up, down, E-stop and the driver's “dead man” harness strap.

### SUMMARY OF THE INVENTION

According to the first aspect of the present invention, a lift elevator is provided. The lift elevator includes a hoist motor, cables, frame work and the lift platform. The lift platform is secured to the lift cables which are guided through the tube frame providing control of the lift platform from lowered to fully raised position.

The size and shape of the frame and platform may be varied in order to compensate for truck/drum size and structure of present cement delivery systems.

The relative position of the lift elevator in the down position would offer a stable platform allowing a bucket of additives to be positioned thereon. With the bucket on the lift platform, the driver can activate the lift platform by pressing an “up” switch.

The lift platform would then raise upward until it engages a “limit switch”. At that point, the lift elevator would stop at the top of its lift. There are switch boxes at both top and bottom of the lift positions. Each would have the up, down and E-stop wash-down protected switches. Accordingly, with the lift platform and loaded bucket now in the upper position, the driver can empty the bucket into the mixer. Upon emptying the bucket, the driver may replace the bucket on the lift platform and press the “down button”, returning the bucket to ground level. The lower “limit switch” is engaged and the lift platform stops allowing the bucket to be removed and refilled as necessary.

In a further embodiment, an improved ladder may be added along with a safety strap connected to a “dead man’ switch allowing an immediate stops if the driver happens to fall from the ladder.

### CONCEPT DRAWINGS

FIG. 1 Illustrates the complete concept

FIG. 2 Illustrates where sections of separations are made

FIG. 3 Illustrates section A/A of the full concept

FIG. 4 Illustrates A/A-B/B of the full concept

FIG. 5 Illustrates section B/B-C/C of the full concept

FIG. 6 Illustrates the lower section C/C of the full concept

### BRIEF DESCRIPTION OF THE DRAWINGS

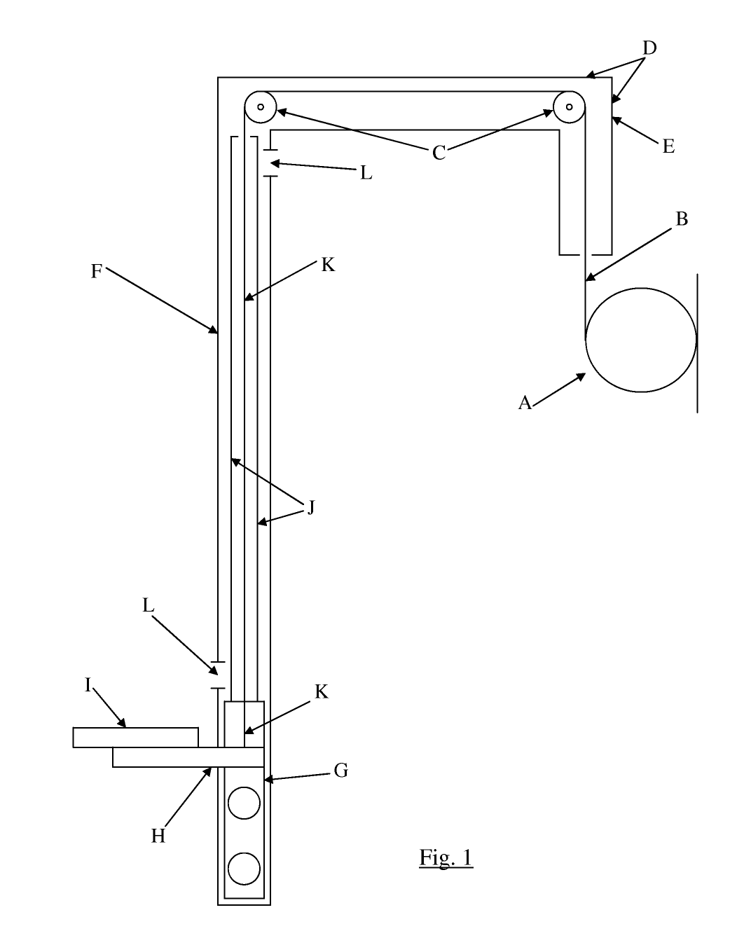

FIG. 1 is an ATV winch

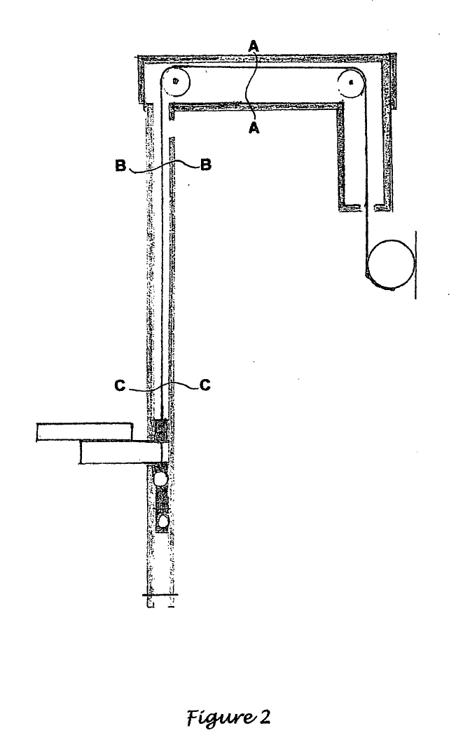

FIG. 2 is a ⅜″ ATV cable

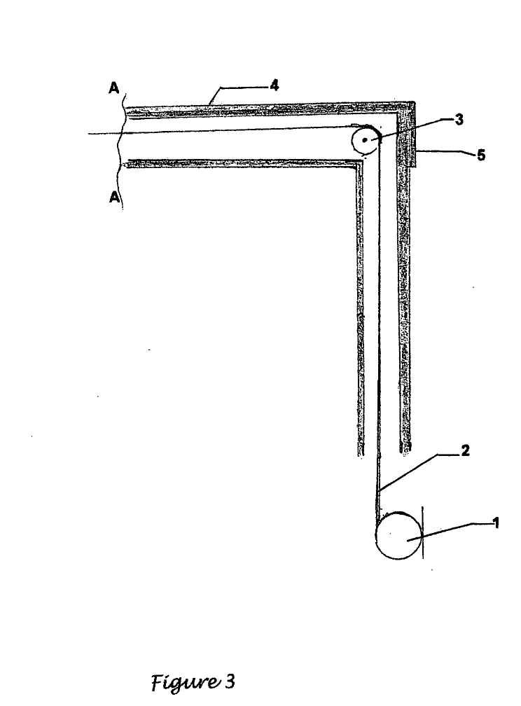

FIG. 3 is two pulley's to guide the cable

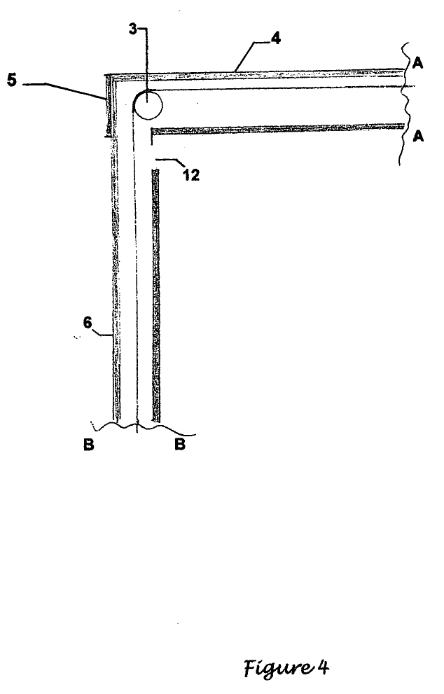

FIG. 4 is tubing to mount item 3 and provide protection to the lift cable.

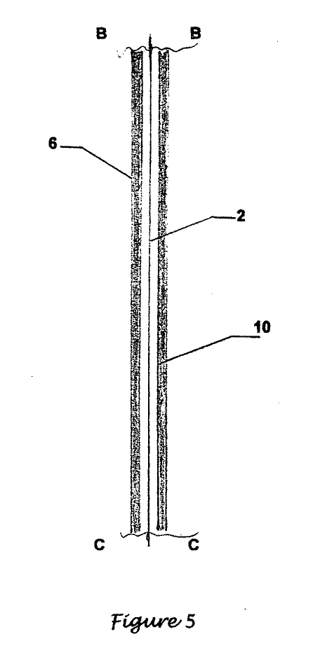

FIG. 5 is a cap at the end of tube 4

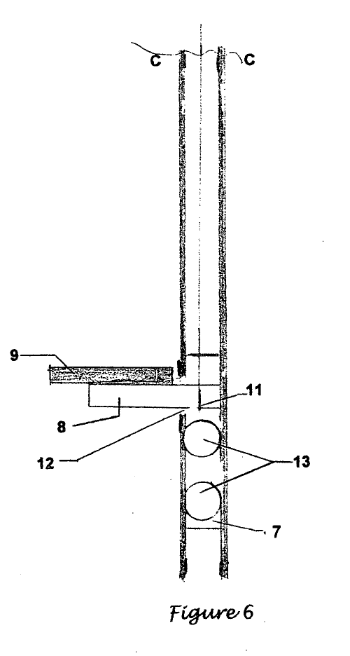

FIG. 6 is a vertical guide tube for the cable and the lift platform

FIG. 7 is an inner tube that carries guide wheels and the lift platform

FIG. 8 is the angle iron frame of the lift platform

FIG. 9 is the bucket mount on the lift platform

FIG. 10 depicts the slots required in the pipe 6 allowing motion up and down with the lift platform

FIG. 11 is the connection point of the lift cable 2 to the lift platform

FIG. 12 is the two cuts in pipe 6 allowing rotary motion of the lift platform as may be required for storage of the platform while the truck is in motion

FIG. 13 is two steel wheels that guide pipe 7 vertically.

### DETAILED DESCRIPTION

Disclosed herein is a lift elevator to be added to a cement truck that eliminates the need for the driver to have to hand carry a loaded bucket up a ladder. This then reduces the possibility of injury to driver or anyone on the ground who may be near the lift point.

FIG. 1 illustrates the full concept consisting of items 1 through 13 as later shown on drawings 2 through 6. Each figure has a function to the whole allowing the hoist platform to travel up and down as guided.

Item 1 is a 12 volt ATV winch that will coil or uncoil a cable Item 2 within the tubular frame. This will be controlled by switches both top and bottom for the driver.

Item 2 is a ⅜″ cable that will control all the motion of said lift.

Item 3 is two pulleys that guide the cable Item 2 through frame Item 4 and Item 6.

Item 4 consists of two pieces of 3″×3″ square tubing that house the pulleys Item 3 and comprises the upper end of the frame for said lift.

Item 5 is a cap that aids in closing end of tube Item 4 protecting the cable Item 2 from contamination.

Item 6 is the vertical side of the frame and encloses lift cable Item 2 which is attached to Item 7.

Item 7 is the inner tube that utilizes two wheels Item 13 and guides Item 8 through Item 6.

Item 8 is the angle iron frame on the lift platform and is secured to Item 7 and provides a frame base for Item 9.

Item 9 is the frame for the bucket to be positioned onto and secured to Item 8.

Item 10 depicts the slot cut into pipe Item 6 allowing the hoist frame Item 8 to be lifted upward by the cable Item 2.

Item 11 is the connection point of cable Item 2 to interior pipe Item 7.

Item 12 illustrates cut out sections on Item 6 allowing rotation of Items 8 & 9 resulting in the platform to be stored in more secure position while the cement truck is in motion or placing a load into the hopper.

Item 13 is two steel wheels that guide Item 7 through the inside of Item 6.

What is claimed is:

1. Lift elevator composing of cable hoist, frame, platform and controls.

2. The lift elevator of claim 1, where in the platform provides easy placement of a bucket of material being raised upward.

3. The lift elevator of claim 1, wherein the platform started upward by the driver is automatically stopped by a limit switch.

4. The lift elevator of claim 1, wherein at the top position maybe relieved of the bucket, bucket dumped into the trucks' mixer, replaced on platform, lowered to the bottom position and automatically stopped by a limit switch.

5. The lift elevator frame, wherein comprised of round and square tubing in a disposed pattern, meeting requirements for additions to truck designs.

6. The lift elevator, wherein cables, guide wheels and connection points control motion guidance throughout the frame.

7. The lift elevator, wherein electrical controls in wash-down boxes are provided capable of all motion requirements as well as safety E-stops.

8. The lift elevator, wherein safety straps and improved ladder designs may be incorporated into the present designs as well as those herein the specified lift elevator.

9. The lift elevator, may be increased in size allowing the Driver to be raised with the bucket and preclude the use of a ladder.
